(19) United States
(12) Patent Application Publication
(10) Pub. No.: US 2002/0135490 A1
(43) Pub. Date: Sep. 26, 2002

(54) Method and device for detecting smoke and/or fire in rooms

(75) Inventors: Daniel Opitz, Erkelenz (DE); Cornelius Hecker, Monchengladbach (DE); Thomas Wittkopp, Barsinghausen/Stemmen (DE)

Correspondence Address: Gudrun E. Huckett, Ph.D., P.O. Box 3187, Albuquerque, NM, 87190-3187, US

(73) Assignee: VIDAIR Aktiengesellschaft, Monchengladbach (DE)

(21) Appl. No.: 10/095,301

(22) Filed: Mar. 8, 2002

(30) Foreign Application Priority Data
Mar. 9, 2001 (EP) 01 105 956.5

(51) Int. Cl. G08B 17/10

(52) U.S. Cl. 340/628; 340/632

(57) ABSTRACT

In a method for detecting smoke or fire in rooms, at least one image of the room is recorded and digitalized to a digitalized image. The digitalized image is compared to a reference image in digitalized form, wherein the reference image is generated based on an image of the room previously recorded and digitalized. The sum of image elements of the digitalized image deviating by at least one first threshold value from the reference image is determined. An alarm signal is generated when the sum reaches or surpasses a second threshold value. The device for performing the method has a video camera and a matching light source arranged in a dark field arrangement.

### BACKGROUND OF THE INVENTION

1. Field of the Invention

The invention relates to the a method and a device for detecting smoke and/or fire in rooms, in particular, in cargo areas or the like.

2. Description of the Related Art

Such methods and devices are conventionally employed in alarm systems for the detection and indication of fires in rooms in order to trigger targeted protection and/or aid measures. Since protection and/or aid measures are extremely cost-intensive, high reliability requirements are imposed in regard to detection of smoke and/or fire, in particular, in the area of freight transport by means of airplanes where, in the case of false alarms by means of protection and/or countermeasures, the goods in the cargo space can be damaged or destroyed by the firefighting measures and in some cases unnecessary landings may have to be carried. Moreover, it is required to detect smoke and/or fire in rooms as quickly as possible.

### SUMMARY OF THE INVENTION

It is an object of the present invention to provide a method and a device of the aforementioned kind which enable an extremely reliable and very fast detection of smoke and/or fire in rooms, in particular, in cargos spaces or the like.

In accordance with the present invention, this is achieved in regard to the method in that at least one image of a room is recorded, digitalized, and compared with a reference image which is present in digitalized form and has been generated based on an image of the room recorded and digitalized at an earlier point in time, wherein the sum of the image elements of the digitalized image which deviate by at least a first threshold value from the reference image is determined and an alarm is generated when the sum of a second threshold value is reached or is surpassed.

By the comparison according to the invention of temporally spaced digitalized images of the room to be monitored, smoke and/or fire in the room can be detected with high reliability and very quickly.

In the context of digitalization the recorded image of the room is subjected to rastering and quantization. When rastering, the image is divided into image elements, or pixels, which are arranged in a matrix of rows and columns. When quantizing, a value is assigned to the individual image elements (pixels). According to the invention, the images are recorded in several different brightness steps, so-called gray scale values, as well as in color. In the digitalization of color images, three chromatic components per color image are digitalized separately.

For characterizing the images which have been compared with one another, according to the invention the sum of the image elements which deviate by at least one first threshold value are determined and, upon reaching or surpassing a second threshold value, an alarm signal is generated. Based on the first threshold value the number of image elements is determined which deviate significantly from the corresponding image element of the reference image. Based on the second threshold value, it is determined whether the number of changing image elements indicate a likelihood of smoke and/or fire in the room to be monitored, wherein an alarm signal is generated in any case.

According to an advantageous embodiment of the invention for improving the reliability of the detection even further, the digitalized image is divided into individual areas, for each of these areas the average value of the image elements corresponding to the area, respectively, is determined and compared with at least one average value of the area determined accordingly at an earlier point in time, wherein an additional alarm signal is generated when the average value at least of one area deviates over a predetermined duration by a predetermined third threshold value. According to the invention, this determines a temporal trend. In a further advantageous configuration of the invention, the temporal fluctuations of the average values of the individual areas are detected and a third alarm signal is generated when the temporal fluctuations of the average value of at least one area are within a predetermined frequency range.

According to the invention, as a function of the reliability requirements, the alarm signals are individually or cumulatively displayed or indicated.

In regard to the device for the detection of smoke and/or fire in rooms, in particular, cargo space or the like, the solution of the aforementioned object resides in an electro-optical device connected to a computing device for recording and digitalizing images of a room and a light source for illuminating the room, wherein the electro-optical device and the light source are positioned relative to one another in a dark field arrangement.

In an advantageous configuration of the invention, the electro-optical device and the light source are adjusted to one another. In an advantageous configuration the light source is adjusted to emit a frequency band which is matched to the electro-optical device. In a further advantageous embodiment of the invention, the electro-optical device and the light source are arranged such that the electro-optical axes are positioned at an angle of between 0° and 170° to one another.

In a further particularly advantageous configuration of the invention the intensity of the light source can be modulated. Advantageously, the light source is connected with a computing device and is controllable by it. In this way, fluctuations of the illumination of the room caused by interference radiation can be eliminated by computation.

Advantageously, the electro-optical device is a video camera, preferably, according to video standard, for example, CCIR standard (Comité Consultatif International de Radiocomunications standard—European television standard), with a CCD (charge-coupled device) image sensor or CMOS (complementary metal oxide semiconductor) image sensor or a CCD image sensor field or CMOS image sensor field. The electro-optical device provides thus images in the form of video signals which can be converted directly electronically or by an analog-to-digital converter into binary data.

Advantageously, the light source has a spectrum between ultraviolet (UV) and infrared (IR).

### BRIEF DESCRIPTION OF THE DRAWING

In the drawing:

FIG. 1 shows a block diagram of the principal sequence of the method according to the invention; and

FIG. 2 illustrates the principal arrangement of an electro-optical device and a light source for a device according to the invention.

### DESCRIPTION OF THE PREFERRED EMBODIMENTS

In the first method step (method step 1) by means of an electro-optical device an image of the room to be monitored is recorded and the image data are digitalized. During digitalization, the image which has been recorded by the electro-optical device is divided by rastering into image elements (pixels) which are arranged like a matrix in columns and rows and quantized, wherein a value is assigned to each image element. In method step 2, the image matrix generated in this way is supplied to a computing unit and stored therein.

In the method step 3, a reference image is generated from the image matrix of the digitalized image in the computing unit. For this purpose, a reference image matrix is stored. In the simplest case, the reference image matrix corresponds to the image matrix. In the context of image enhancement, the reference image is generated as a reference image matrix based on the image matrix of the digitalized image with the aid of expanded contrast methods, smoothing methods, and/or edge extraction methods in local range or frequency range.

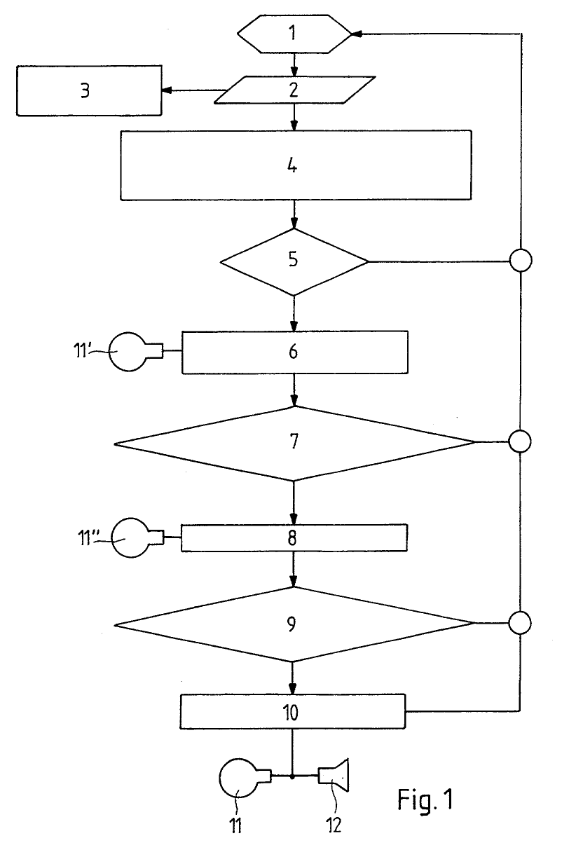

In the method step 4 of FIG. 1, the computing unit compares the image elements (pixels) of the image matrix with the image elements (pixels) of the reference image matrix and the sum of the image elements of the image matrix deviating from a first threshold value are determined. In the method step 5, the computing unit compares the sum of the thus determined image elements with a second threshold value. Inasmuch as the sum of the changing image elements is smaller than the second threshold value, the method is continued with method step 1. When the sum of the changing image elements is greater than the second threshold value, a first alarm signal is generated which causes, according to the method step 6, the computing unit to divide the image matrix representing the digitalized image into areas, to determine for each of these areas the average value of the values of the image elements corresponding to this area and to store the average values in an average value matrix. In the comparison according to method step 7 of FIG. 1, the momentarily determined average values of the respective areas are compared with at least one average value of the respective areas determined at least at one previous point in time, present in the form of stored average value matrices. When the average value of at least one area deviates for a predetermined duration by at least one predetermined third threshold value, a second alarm signal is generated in method step 8. When in the comparison in method step 7 according to FIG. 1 none of the average values of the average value matrix deviates over the predetermined duration from the predetermined third threshold value, the method is continued with method step 1.

In the method step 9, by means of the average value matrices stored in the computing unit, the temporal fluctuations of the average values of the individual areas are determined. In the context of comparison according to method step 9, a third alarm signal is generated in the method step 10 when the temporal fluctuations of the average value at least of one area are within a predetermined frequency range. The frequency range is preset such that it is characteristic for smoke and/or fire in the room to be monitored. When the temporal fluctuations of the average values of the individual areas are outside of the predetermined frequency range, the method is continued with method step 1 after the comparison according to method step 9, as illustrated in the FIG. 1.

In the method step 10, the third generated alarm signal is optically or acoustically indicated by means of a luminous display 11 or a loudspeaker 12, and the method is continued with method step 1.

Moreover, the first alarm signal in the method step 6 and the second alarm signal in the method step 8 are indicated by luminous display 11′ or 11″, respectively. An operator can thus be made aware of smoke and/or fire in a room to be monitored by means of the luminous displays 11′, 11″ or 11 and the loudspeaker 12 in a step-wise fashion.

The threshold values used in the method steps 4 and 5 are empirically determined comparative values which are stored in the computing unit. The third threshold value used in method step 7 for classifying the average values is determined according to heuristic rules and stored in the computing unit in matrices of points in time. The frequency range used in method step 9 for characterizing temporal fluctuations of the average values of the individual areas is empirically determined by means of characteristic fluctuations of smoke density and/or radiation emission of the fire and is stored in the computing unit.

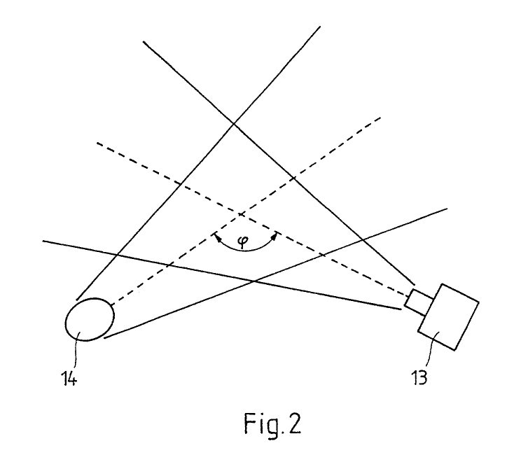

FIG. 2 shows a device for detection of smoke and/or fire in rooms comprising an electro-optical device 13 for recording images of the room to be monitored, in the present embodiment a CCD camera, and a light source 14. FIG. 2 shows that the electro-optical device 13 and the light source 14 are positioned in a dark field arrangement relative to one another wherein the optical axes, indicated in FIG. 2 in dashed lines, of the electro-optical device 13 and of the light source 14 are positioned at an angle φ of between 0° and 170° relative to one another. The light source 14 emits a frequency band or wavelength range that is adjusted or matched to the electro-optical device 13.

While specific embodiments of the invention have been shown and described in detail to illustrate the inventive principles, it will be understood that the invention may be embodied otherwise without departing from such principles.

What is claimed is:

1. A method for detecting smoke and/or fire in rooms, comprising the steps of:
recording at least one image of the room;
digitalizing the at least one image of the room to a digitalized image;
comparing the digitalized image to a reference image in digitalized form which reference image is generated based on an image of the room previously recorded and digitalized;
determining the sum of image elements of the digitalized image deviating by at least one first threshold value from the reference image; and
generating an alarm signal when the sum reaches or surpasses a second threshold value.

2. The method according to claim 1, further comprising the steps of:
dividing the digitalized image into individual areas;
determining for each of the individual areas the average value of the width of the image elements belonging to the individual area, respectively;
comparing the average value with at least one correspondingly previously determined average value of the individual area, respectively; and
generating a second alarm signal when the average value of at least one of the individual areas over a predetermined duration deviates from a predetermined third threshold value.

3. The method according to claim 2, further comprising the steps of:
determining the temporal fluctuations of the average value of the individual areas; and
generating a third alarm signal when the temporal fluctuations of the average value of at least one of the individual areas is within a predetermined frequency range.

4. The method according to claim 3, wherein at least one of the first, second, and third alarm signals is displayed.

5. The method according to claim 2, wherein at least one of the first and second alarm signals is displayed.

6. The method according to claim 1, wherein the first alarm signal is displayed.

7. A device for detection and indication of smoke and/or fine air in rooms, the device comprising:
a computing unit;
at least one electro-optical device (13), for recording images of a room, connected to the computing device;
at least one light source (14) for illuminating the room, wherein the at least one electro-optical device (13) and the at least one light source (14) are positioned in a dark field arrangement relative to one another.

8. The device according to claim 7, wherein the electro-optical device (13) and the light source (14) have optical axes positioned at an angle of 0° to 170° relative to one another.

9. The device according to claim 7, wherein the electro-optical device (13) and the light source (14) are adjusted to one another.

10. The device according to claim 9, wherein the light source (14) emits light in a frequency band adjusted to the electro-optical device (13).

11. The device according to claim 7, wherein the light source (14) has a modulated intensity.

12. The device according to claim 11, wherein the light source (14) is connected to the computing unit and the computing unit controls the light source (14).

13. The device according to claim 7, wherein the electro-optical device (13) is a video camera.
